(19) United States
(12) Patent Application Publication
(10) Pub. No.: US 2026/0097718 A1
(43) Pub. Date: Apr. 9, 2026

(54) CAR CUP MOUNT HOLDER

(71) Applicant: Fan Yu, Shenzhen (CN)

(72) Inventor: Fan Yu, Shenzhen (CN)

(21) Appl. No.: 19/370,797

(22) Filed: Oct. 28, 2025

Related U.S. Application Data
(63) Continuation-in-part of application No. PCT/CN2023/091476, filed on Apr. 28, 2023.

(51) Int. Cl. B60R 11/02; B60R 11/00

(52) U.S. Cl. CPC B60R 11/0241; B60R 2011/0007; B60R 11/0252

(57) ABSTRACT

A car cup mount holder includes a support body and a holder body. The support body includes a body portion and two flexible engaging arms connected to two sides of the body portion for elastically abutting against a wall of a car cup mount. The flexible engaging arms and the body portion together form an accommodating room for accommodating a cup. The support body is connected to the holder body, providing multi-directional practicality for holding mobile phones or tablets in the car while preserving the function of the car cup mount for accommodating a cup. The structure is ingenious.

### BACKGROUND OF THE INVENTION

### 1. Field of the Invention

The present invention relates to a car holder, and more particularly to a car cup mount holder.

### 2. Description of the Prior Art

While driving, electronic devices such as smartphones and tablets can provide drivers with various functions such as route navigation, voice calls, and multimedia entertainment, offering an excellent driving experience. To meet the diverse needs for electronic devices while driving, there are a variety of vehicle-mounted holders on the market, such as dashboard mount holders, air vent mount holders, headrest mount holders, and car cup mount holders.

Chinese Patent No. ZL202221589229.X discloses a car cup mount holder, comprising a support rod, an electronic device clamp, a cup mount fixing mechanism, an adjustment mechanism, a tubular seat, and a fixing rod. The adjustment mechanism includes a screw rod and a knob. The screw rod is fitted inside the knob so that the knob can be turned to rotate the screw rod. The screw rod has a through hole running from top to bottom. One end of the fixing rod passes through the through hole and is fixedly connected to the bottom of the cup mount fixing mechanism. The other end of the fixing rod is connected to the bottom of the tubular seat. The top of the tubular seat is connected to the other end of the support rod. The adjustment mechanism enables the cup mount fixing mechanism to act on the inner wall of the car cup mount to generate a tightening force. It enables the release and securing of the car cup mount holder, meeting the needs of any passenger for using the vehicle-mounted holder and expanding its range of applications. However, it has many shortcomings, such as: 1. The structure of the adjustment mechanism is relatively complex, increasing the overall weight of the car cup mount holder. With numerous components, assembly is inconvenient and production cost is high. 2. Due to the diverse shapes of car cup mounts (which may be square, round, oval, etc.), the car cup mount holder cannot accommodate car cup mounts of different shapes, resulting in poor compatibility. 3. The car cup mount is designed to neatly accommodate cups of corresponding sizes, meeting the drinking needs of drivers and passengers. However, installing the car cup mount holder may render the car cup mount incapable of meeting the drinking needs of users.

In the PCT examination stage of PCT/CN2023/091476, the examiner considered that the combination of the cited references D1 (CN214607233U) and D2 (CN216468203U) affected the non-obviousness of this application. As disclosed in the description, abstract and FIG. 1 of the cited reference CN214607233U, the base is secured in the car cup mount via a telescopic block, and a cup accommodating room is connected to the top of the base. When in use, the cup accommodating room is above the car cup mount. As disclosed in the description, abstract and FIG. 1 of the cited reference CN216468203U, the clamping seat is mounted on the mounting base and needs to be secured by the mounting base. The clamping seat is only used for accommodating cups. The clamping seat has the same function as the cup accommodating room of the cited reference CN214607233U and cannot be used to replace the base of the cited reference CN214607233U.

Therefore, it is necessary to develop a new technical solution to solve the above problems.

### SUMMARY OF THE INVENTION

In view of the deficiencies of the prior art, the primary object of the present invention is to provide a car cup mount holder, which comprises two flexible engaging arms to elastically abut against the wall of a car cup mount, such that the flexible engaging arms and the car cup mount together form a retaining seat for supporting a holder body. The structure is simple and the installation is easy. The flexible engaging arms are designed to fit car cup mounts of various shapes, having excellent compatibility. The flexible engaging arms are rotatable relative to the car cup mount when installed in the car cup mount, providing flexible adjustment and avoiding interference with the shift lever. The body portion and the flexible engaging arms together form an accommodating room for accommodating a cup, without affecting the function of the car cup mount for accommodating a cup. The structure is ingenious.

In order to achieve the above object, the present invention adopts the following technical solutions:

According to one aspect of the present invention, a car cup mount holder comprises a support body and a holder body. The holder body includes a connecting arm connected to the support body and a connector connected to the connecting arm.

The support body includes a body portion and two flexible engaging arms connected to two sides of the body portion for elastically abutting against a wall of a car cup mount. The flexible engaging arms and the body portion together form an accommodating room for accommodating a cup.

The connector is movably disposed on the body portion via the connecting arm.

According to another aspect of the present invention, a car cup mount holder comprises a support body and a holder body.

The support body includes a body portion and two flexible engaging arms connected to two sides of the body portion for elastically abutting against a wall of a car cup mount. The flexible engaging arms and the body portion together form an accommodating room for accommodating a cup.

The holder body and the body portion are connected by a quick-release structure. The quick-release structure includes a docking part and a mating part that mates with the docking part. One of the docking part and the mating part is disposed on the holder body. The other of the docking part and the mating part is disposed on the body portion. The quick-release structure allows the driver to quickly remove the holder body with one hand to expand the car's interior space.

Compared with the prior art, the present invention has obvious advantages and beneficial effects. Specifically, as can be seen from the above technical solution:
The flexible engaging arms elastically abut against the wall of the car cup mount, so that the flexible engaging arms and the car cup mount together form a retaining seat for supporting the holder body. The structure is simple and the installation is easy. The flexible engaging arms are designed to fit car cup mounts of various shapes, having excellent compatibility. The flexible engaging arms are rotatable relative to the car cup mount when installed in the car cup mount, providing flexible adjustment and avoiding interference with the shift lever. The body portion and the flexible engaging arms together form the accommodating room for accommodating a cup, without affecting the function of the car cup mount for accommodating a cup. The structure is ingenious. Through a quick-release structure, the holder body is detachably connected to the body portion via the quick-release structure, such that the holder body can be removed quickly from the support body. When storing, only the holder body needs to be stored, occupying minimal storage space for greater flexibility in use.

### BRIEF DESCRIPTION OF THE DRAWINGS

FIG. 1 is a front perspective view of a first embodiment of the present invention;

FIG. 2 is a rear perspective view of the first embodiment of the present invention;

FIG. 3 is a front perspective view of a second embodiment of the present invention;

FIG. 4 is a rear perspective view of the second embodiment of the present invention;

FIG. 5 is a front perspective view of a third embodiment of the present invention;

FIG. 6 is a rear perspective view of the third embodiment of the present invention;

FIG. 7 is a perspective view of a fourth embodiment of the present invention;

FIG. 8 is an exploded view of the fourth embodiment of the present invention;

FIG. 9 is a cross-sectional view of the fourth embodiment of the present invention;

FIG. 10 is an enlarged view of circle A in FIG. 9; and

FIG. 11 is a schematic view showing the installation of the locking assembly of the fourth embodiment of the present invention.

### DETAILED DESCRIPTION OF THE PREFERRED EMBODIMENTS

Embodiments of the present invention will now be described, by way of example only, with reference to the accompanying drawings.

Spatially relative terms, such as “upper,” “lower,” “left,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures.

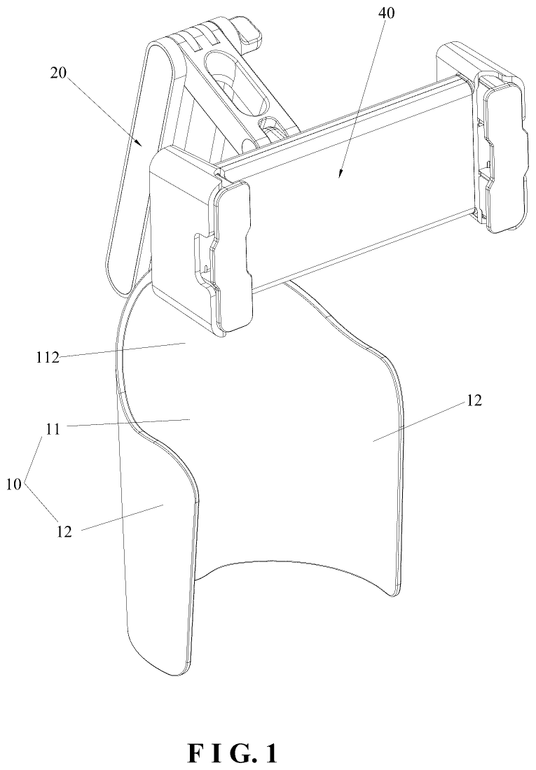

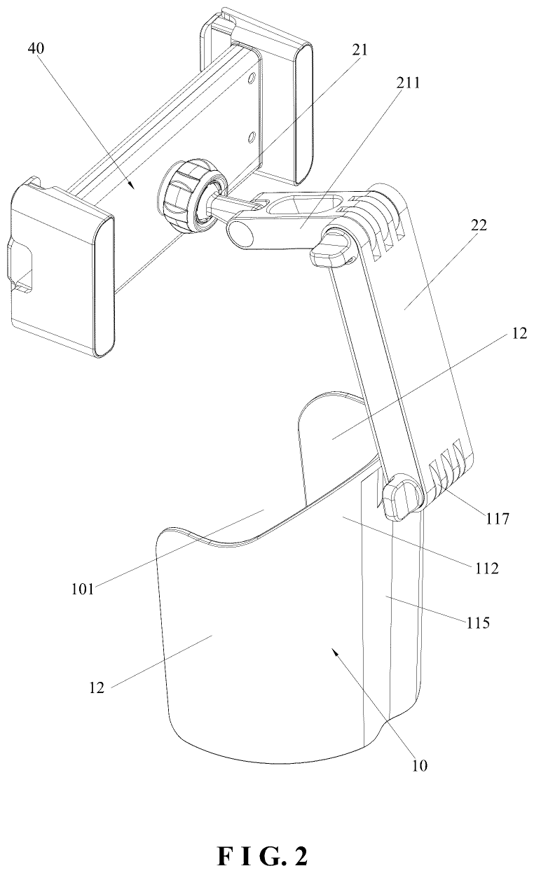

FIG. 1 and FIG. 2 show the specific structure of a first embodiment of the present invention. The present invention discloses a car cup mount holder, comprising a support body 10 and a holder body 20. The holder body 20 includes a connector 21 and a connecting arm 22 connecting the connector 21 and the support body 10.

The support body 10 includes a body portion 11 and two flexible engaging arms 12 connected to two sides of the body portion 11 for elastically abutting against the wall of a car cup mount. The flexible engaging arms 12 and the body portion 11 together form an accommodating room 101 for accommodating a cup. The flexible engaging arms 12 and the car cup mount together form a support base for supporting the connecting arm 22. The structure is simple and the installation is easy. The flexible engaging arms 12 are designed to fit car cup mounts of various shapes (such as round, square, etc.), ensuring excellent compatibility. The flexible engaging arms 12 are rotatable relative to the car cup mount when installed in the car cup mount, allowing the connector 21 to rotate 360 degrees relative to the car cup mount for flexible adjustment and to avoid interference with the shift lever. The body portion 11 and the flexible engaging arms 12 together form the accommodating room 101 for accommodating a cup. The car cup mount can hold a cup while being used as a car cup mount holder, without affecting the function of accommodating a cup. The structure is ingenious.

Specifically, the flexible engaging arm 12 gradually tapers from the end connected to the body portion 12 toward a free end thereof. In this structure, the body portion 11 is thicker to provide good support for the connecting arm 22 and is not easy to deform. The flexible engaging arm 12 is thinner to make it easier to bend and deform, which is convenient for disassembly and assembly in the car cup mount. Preferably, the elastic engaging arms 12 extend from the body portion 11. The elastic engaging arms 12 are integrally formed with the body portion 11, facilitating the fabrication of the support body 10.

Preferably, the body portion 11 has a first reinforcing portion 113 in the form of a rib extending downward on the inner side or the outer side of the accommodating room 101. Two sides of the first reinforcing portion 113 are connected to the respective flexible engaging arms 12 through first curved portions 114. The first reinforcing portion 113 is configured for enhancing the structural strength of the body portion 11. The first curved portions 114 are configured for connecting the first reinforcing portion 113 and the flexible engaging arms 12, enabling more even distribution of the stress from the first reinforcing section 113 to the flexible engaging arms 12 at both sides of the first reinforcing portion 113. The stress transfer extends even into the interior of the car cup mount, further enhancing the structural strength of the body portion 11. In order to support the connecting arm 22 better, a recessed portion 115 may be disposed on the outer side of the accommodating room 101 of the body portion 11. The recessed portion 115 can save the material for the body portion 11. The first reinforcing portion 113 and the recessed portion 115 together form an arched structure, thereby enhancing the structural strength of the body portion 11, such that the stress applied to the first reinforcing portion 113 by the connecting arm 22 is more effectively distributed to the first curved portions 114, the second curved portions 116 and the flexible engaging arms 12. In practice, the thickness of the body portion 11 is greater than the thickness of the flexible engaging arms 12. The structural strength of the body portion 11 is improved by thickening to support the connecting arm 22 better.

In this embodiment, the flexible engaging arms 12 are curved. The inner concave surfaces of the two flexible engaging arms 12 face each other, enhancing the aesthetic appeal and balance of the support body 10. The two flexible engaging arms 12 and the body portion 11 surround the accommodating room 101 for accommodating a cup. The connector 21 is configured for mounting an electronic device holding device 40. In use, the connector 21 may be equipped with an electronic device holding device 40 for holding electronic devices (e.g., mobile phones, etc.). In this embodiment, one end of the connector 21 is a universal ball joint. The connector 21 may be a universal ball joint mounting seat. The connector 21 is prior art, not limited thereto. The electronic device holding device 40 may be a clamping holder or a magnetic holder, but not limited thereto.

The connector 21 is movably disposed on the body portion 11 via the connecting arm 22, so that the position of the connector 21 relative to the support body 10 can be adjusted. This allows users to adjust the position of the electronic device relative to the support body 10 for greater flexibility in use.

Specifically, a connecting portion 112 extends upward from the top of the body portion 11. The connecting portion 112, the flexible engaging arms 12 and the body portion 11 are integrally formed. Two sides of the connecting portion 112 are connected to the respective flexible engaging arms 12 through second curved portions 116. The connector 21 is movably disposed on the connecting portion 112 through the connecting arm 22. The side surface or top surface of the connecting portion 112 has a hinge mounting portion 117. One end of the connecting arm 22 is hinged to the hinge mounting portion 117. The connector 21 is located at the other end of the connecting arm 22. The connecting arm 22 is rotatable relative to the support body 10, thereby adjusting the position of the connector 21 relative to the support body 10.

The hinged structure is a well-known technology in this field and will not be elaborated upon hereinafter. The connecting portion 112 is higher than the flexible engaging arms 12. The connecting portion 112 is located above the car cup mount when the body portion 11 is mounted in the car cup mount, providing space for the installation and adjustment of the connecting arm 22. The configuration of the second curved portions 116 forms a curved wall above the flexible engaging arms 12 and beside the connecting portion 112. On the one hand, when the connecting portion 112 supports the holder body 20 and the electronic device on the holder body 20, the stress will be smoothly transmitted and distributed to the flexible engaging arms 12 along the curved wall, thereby improving the structural strength of the body portion 11. On the other hand, when the car cup mount is deep, the connecting portion 112 and the curved wall are located in the car cup mount, so that the support body 10 can hold the cup more stably. Portion of the curved wall, extending out of the car cup mount, acts as a guide, allowing the cup to be accurately placed in the accommodating room 101. The top surface of the connecting portion and/or the top surface of the second curved portion is an inclined surface 118 oriented towards the accommodating room. The inclined surface 118 facilitates the insertion of the cup into the accommodating room 101 while preventing scratches to the user's hands.

In this embodiment, the hinge mounting portion 117 is disposed on one side of the connecting portion 112, facing away from the accommodating room 101. One end of an extension arm 211 is hingedly connected to the connector 21. The other end of the extension arm 211 is hingedly connected to the other end of the connecting arm 22. Both the extension arm 211 and the connecting arm 22 are hingedly mounted and can be adjusted in multiple stages, thereby adjusting the position of the connector 21 relative to the body portion 11.

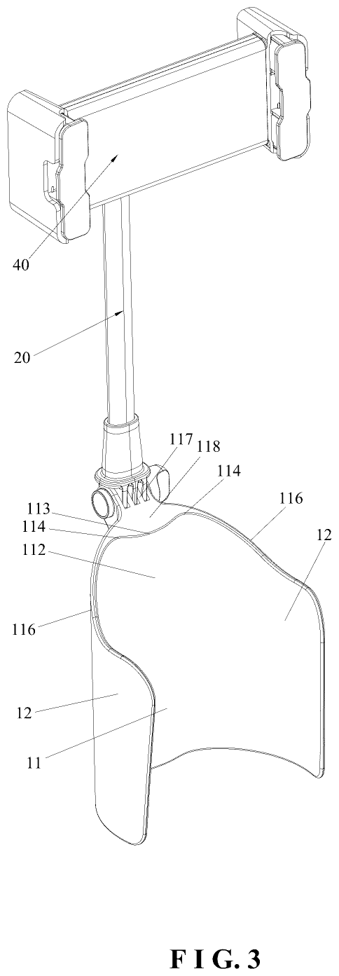

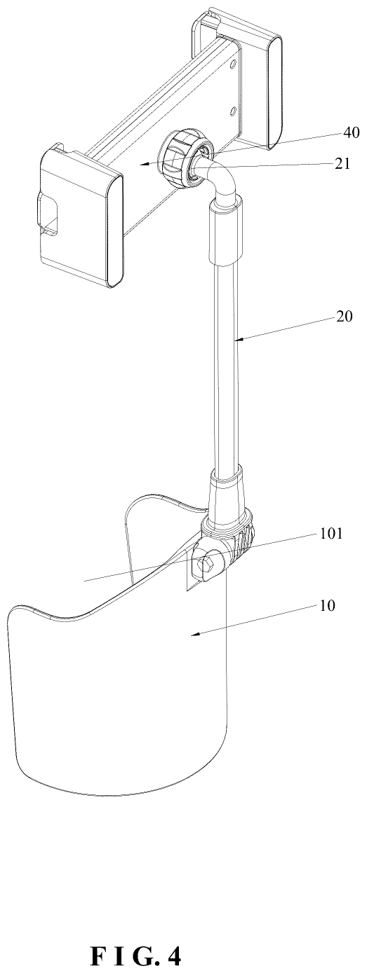

FIG. 3 and FIG. 4 show the specific structure of a second embodiment of the present invention. The second embodiment is substantially similar to the first embodiment with the exceptions described below.

In the second embodiment, the connecting arm 22 is a foldable connecting arm. The foldable connecting arm allows it to be bent and adjusted, thereby adjusting the position of the connector 21 relative to the support body 10. Both the connector 21 and the hinge mounting portion 117 are provided with connecting members for insertion of the foldable connecting arm.

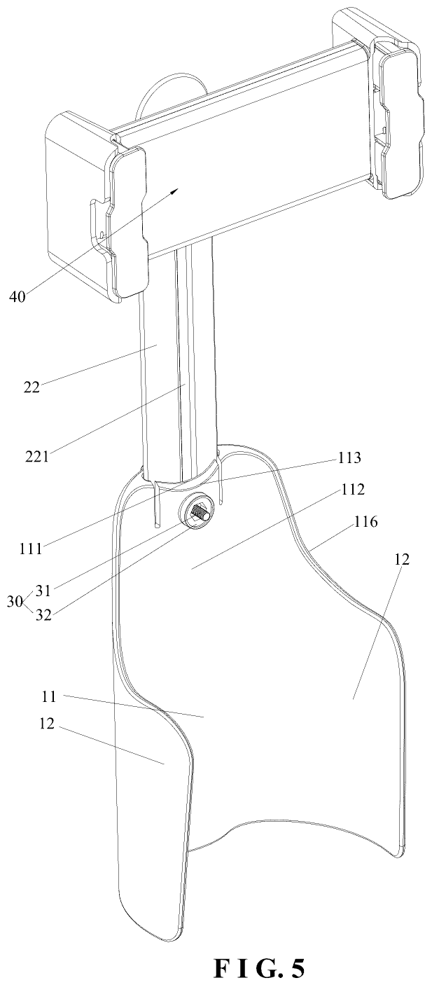

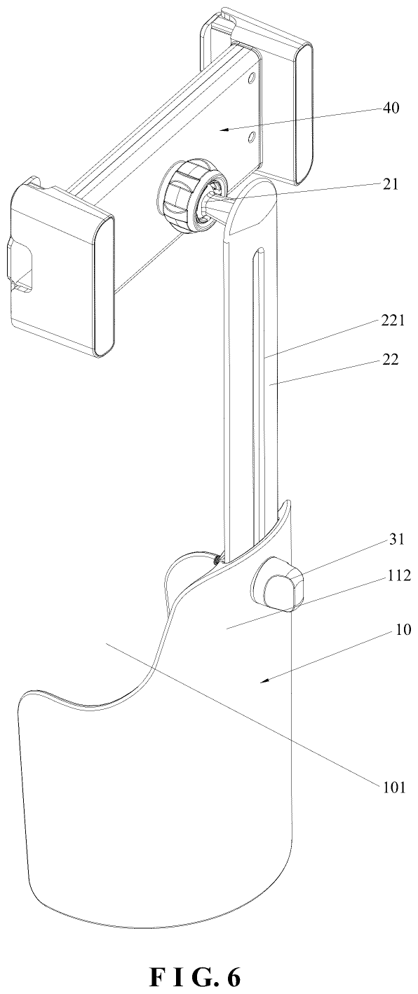

FIG. 5 and FIG. 6 show the specific structure of a third embodiment of the present invention. The third embodiment is substantially similar to the first embodiment with the exceptions described below.

The connecting arm 22 is slidably disposed on the connecting portion 112, such that the distance between the connector 21 and the connecting portion 112 can be adjusted in the sliding direction, thereby adjusting the position of the connector 21 relative to the connecting portion 112.

Specifically, the top surface of the connecting portion 112 has a receiving groove 111 extending downward. The connecting arm 22 is slidably disposed in the receiving groove 111. A guide groove 221 is formed on the connecting arm 22. The connecting portion 112 is provided with a locking member 30 that mates with the guide groove 221 to secure the current position of the connecting arm 22 in the receiving groove 111. The locking member 30 is a well-known technology in the field. The locking member 30 may be a screw-and-nut mating structure, that is, the locking member 30 includes a screw 31 and a nut 32.

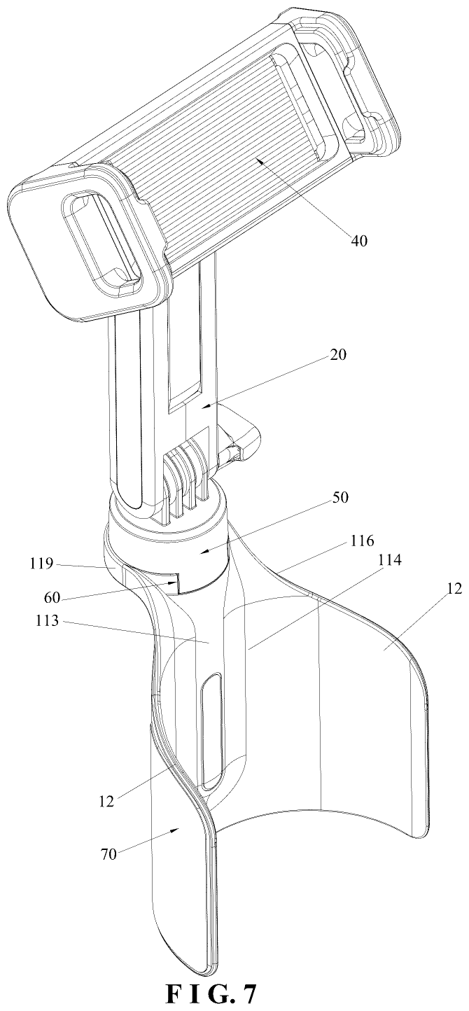

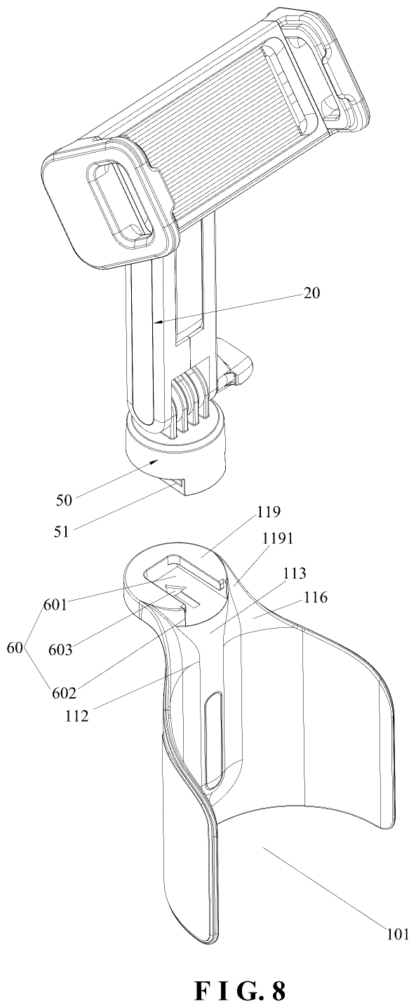

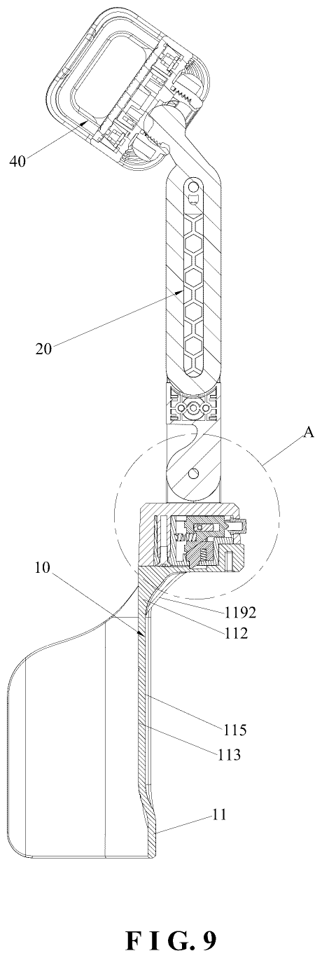

FIGS. 7 to 11 show the specific structure of a fourth embodiment of the present invention. The fourth embodiment is substantially similar to the first embodiment with the exceptions described below.

In the fourth embodiment, the holder body 20 and the connecting portion 112 are connected by a quick-release structure. The quick-release structure includes a docking part 50 and a mating part 60 that mates with the docking part 50. One of the docking part 50 and the mating part 60 is disposed on the holder body 20, and the other is disposed on the connecting portion 112.

The mating part 60 is disposed on the top of the connecting portion 112. The mating part 60 includes a slide groove 601 and an opening 602 communicating with the slide groove 601 for the mating part 50 to be inserted. The docking part 50 is disposed on the holder body 20. The docking part 50 includes a slide block 51 and a locking assembly 52 on the slide block 51. The slide block 51 is slidably connected to the slide groove 601. The locking assembly 52 selectively locks the slide block 51 in the slide groove 601 or unlocks the slide block 51. The top of the connecting portion 112 extends away from the accommodating room 101 to form a support platform 119. The opening 602 faces the accommodating room 101. Two sides of the support platform 119 are connected to the tops of the second curved portions 116 via second reinforcing portions 1191. A reinforcing rib 1192 is connected between the underside of the support platform 119 and the connecting portion 112. The support platform 119 provides a mounting support position for the holder body 20. The second reinforcing portions 1191 and the reinforcing rib 1192 enhance the connection strength between the support platform 119 and the connecting portion 112, preventing damage due to the weight of the holder body 20.

In some other embodiments, the opening 103 may face away from the accommodating room 101. In some other embodiments, the slide groove 601 is disposed on the side wall of the connecting portion, facing away from the accommodating room 101, and the opening 103 faces upward.

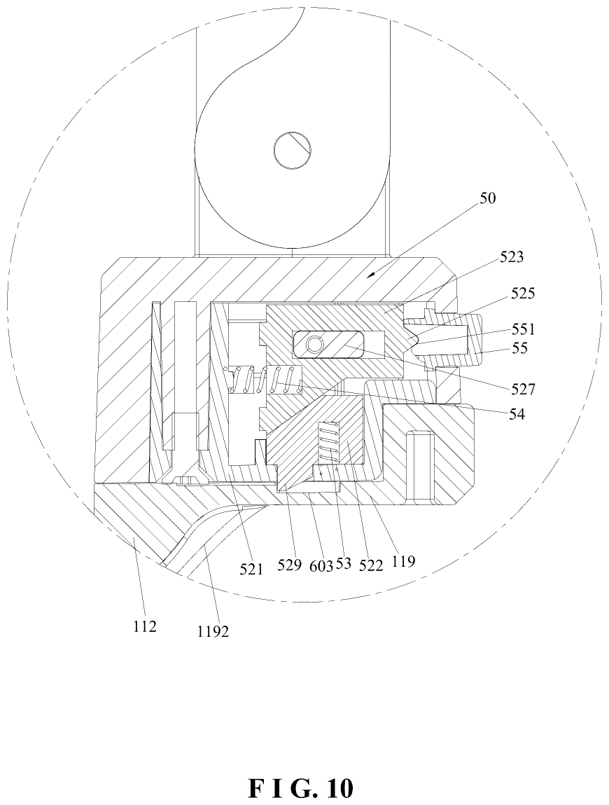

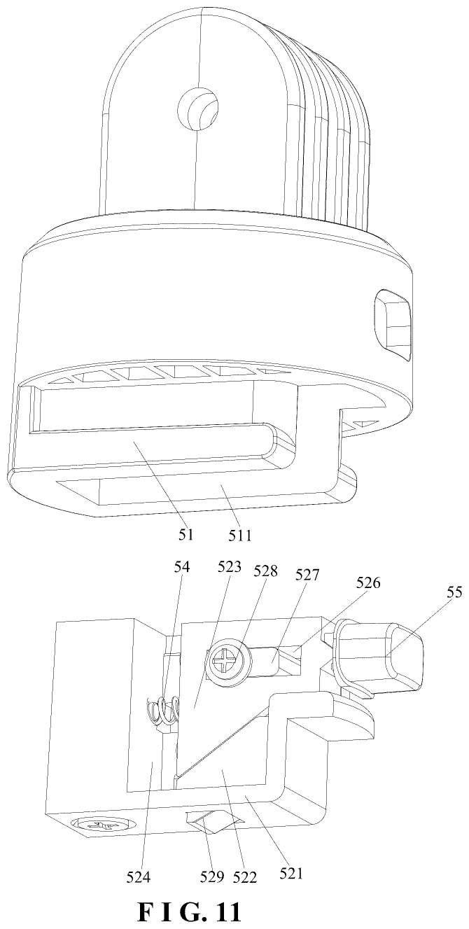

Specifically, referring to FIG. 10 and FIG. 11, the locking assembly 52 includes a mounting member 521, a locking member 522, and an unlocking member 523. The bottom of the slide block 51 has a mounting groove 511 extending upward. The mounting member 521 is mounted in the mounting groove 511. The mounting member 521 has a mounting cavity 524 therein. The locking member 522 is slidably disposed in the mounting cavity 524 to slide upward and downward. The slide groove 601 is formed with an engaging groove 603 for engagement of the locking member 522. A first elastic member 53 is provided between the bottom of the locking member 522 and the mounting member 521. The unlocking member 523 is slidably disposed in the mounting cavity 524 to slide forward and backward and abuts against the locking member 522. A second elastic member 54 is provided between one side of the unlocking member 523 and the mounting member 521. The elastic force of the second elastic member 54 drives the unlocking member 523 to press downward against the locking member 522. The locking assembly 52 has a locked state and an unlocked state. In the locked state, the unlocking member 523 drives the locking member 522 to overcome the elastic force of the first elastic member 53 and engage in the engaging groove 603. In the unlocked state, the unlocking member 523 is driven to overcome the elastic force of the second elastic member 54, causing the locking member 522 to disengage from the engaging groove 603 under the elastic force of the first elastic member 53. The bottom of the locking member 522 has an engaging protrusion 529 to be engaged in the engaging groove 603. Both the first elastic member 53 and the second elastic member 54 are springs.

Furthermore, the locking assembly 52 further includes a button 55. One end of the button 55, facing away from the unlocking member 523, protrudes beyond the slide block 51. Another end of the button 55, facing the unlocking member 523, has a notch 551. The unlocking member 523 has a protruding head 525 that mates with the notch 551. The button 55 abuts against the unlocking member 523 through the engagement of the protruding head 525 and the notch 551.

The unlocking member 523 further has a guide slot 526. The mounting member 521 has a guide block 527 protruding towards the guide slot 526. The unlocking member 523 is slidably disposed in the mounting cavity 524 to slide forward and backward through the engagement of the guide block 527 and the guide slot 526. An anti-disengagement member 528 is provided on the guide block 527 for preventing the unlocking member 523 from disengaging from the guide block 527. The anti-disengagement member 528 is a screw. The mounting member 521 is fixed in the mounting groove 511 by a screw.

When the docking part 50 is to be mounted, the slide block 51 is inserted into the slide groove 601, and the locking member 522 is moved upward under the action of the bottom wall of the slide groove 601, and the locking member 522 drives the unlocking member 523 to compress the second elastic member 54. When the engaging protrusion 529 is pushed into the engaging groove 603, the second elastic member 54 releases its elastic force, driving the locking protrusion 529 to be tightly engaged with the engaging groove 603.

When the docking part 50 is to be dismounted, the button 55 is pressed, and then the button 55 pushes the unlocking member 523 forward, overcoming the elastic force of the second elastic member 54, such that the unlocking member 523 and the locking member 522 are separated instantly. At this time, the locking member 522 is moved upward under the action of the first elastic member 53 to abut against the unlocking member 523 again. Thus, the locking protrusion 529 on the locking member 522 is retracted into the mounting cavity 524, thereby unlocking and enabling disassembly. During this process, the unlocking member 523 abuts against the locking member 522 via a guide inclined surface.

Referring to FIG. 7, a first anti-slip pad 70 is provided on one side of the flexible engaging arms 12, facing away from the accommodating room 101. The first anti-slip pad 70 prevents the flexible engaging arms 12 from rotating when secured in the car cup mount, thereby enhancing the stability of the electronic device holding device 40 when securing mobile phones and other electronic devices.

The feature of the present invention is described below.

The flexible engaging arms elastically abut against the wall of the car cup mount, so that the flexible engaging arms and the car cup mount together form a retaining seat for supporting the holder body. The structure is simple and the installation is easy. The flexible engaging arms are designed to fit car cup mounts of various shapes, having excellent compatibility. The flexible engaging arms are rotatable relative to the car cup mount when installed in the car cup mount, providing flexible adjustment and avoiding interference with the shift lever. The body portion and the flexible engaging arms together form the accommodating room for accommodating a cup, without affecting the function of the car cup mount for accommodating a cup. The structure is ingenious. Through a quick-release structure, the holder body is detachably connected to the body portion via the quick-release structure, such that the holder body can be removed quickly from the support body. When storing, only the holder body needs to be stored, occupying minimal storage space for greater flexibility in use.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A car cup mount holder, comprising a support body and a holder body, the holder body including a connecting arm connected to the support body and a connector connected to the connecting arm;
the support body including a body portion and two flexible engaging arms connected to two sides of the body portion for elastically abutting against a wall of a car cup mount, the flexible engaging arms and the body portion together forming an accommodating room for accommodating a cup;
the connector being movably disposed on the body portion via the connecting arm.

2. The car cup mount holder as claimed in claim 1, wherein the body portion has a first reinforcing portion in the form of a rib extending downward on an inner side or an outer side of the accommodating room, and two sides of the first reinforcing portion are connected to the respective flexible engaging arms through first curved portions.

3. The car cup mount holder as claimed in claim 1, wherein the body portion has a thickness greater than that of the flexible engaging arms for supporting the connecting arm.

4. The car cup mount holder as claimed in claim 1, wherein a connecting portion extends upward from a top of the body portion, two sides of the connecting portion are connected to the respective flexible engaging arms through second curved portions, and the connector is movably disposed on the connecting portion through the connecting arm.

5. The car cup mount holder as claimed in claim 4, wherein a top surface of the connecting portion and/or a top surface of each of the second curved portions is an inclined surface oriented towards the accommodating room.

6. The car cup mount holder as claimed in claim 4, wherein a side surface or a top surface of the connecting portion has a hinge mounting portion, one end of the connecting arm is hinged to the hinge mounting portion, and the connector is located at another end of the connecting arm.

7. The car cup mount holder as claimed in claim 5, wherein the connecting arm is a foldable connecting arm.

8. The car cup mount holder as claimed in claim 4, wherein the connecting portion, the body portion, and the flexible engaging arms are integrally formed.

9. The car cup mount holder as claimed in claim 4, wherein a top surface of the connecting portion has a receiving groove extending downward, the connecting arm is slidably disposed in the receiving groove, a guide groove is formed on the connecting arm, the connecting portion is provided with a locking member that mates with the guide groove, and the locking member is configured for securing the connecting arm in the receiving groove.

10. The car cup mount holder as claimed in claim 1, wherein the flexible engaging arm gradually tapers from one end connected to the body portion toward a free end thereof.

11. A car cup mount holder, comprising a support body and a holder body;
the support body including a body portion and two flexible engaging arms connected to two sides of the body portion for elastically abutting against a wall of a car cup mount, the flexible engaging arms and the body portion together forming an accommodating room for accommodating a cup;
the holder body and the body portion being connected by a quick-release structure, the quick-release structure including a docking part and a mating part that mates with the docking part, one of the docking part and the mating part being disposed on the holder body, the other of the docking part and the mating part being disposed on the body portion.

12. The car cup mount holder as claimed in claim 11, wherein a connecting portion extends upward from a top surface of the body portion, two sides of the connecting portion are connected to tops of the respective flexible engaging arms through second curved portions, the mating part is disposed on the connecting portion, the mating part includes a slide groove and an opening communicating with the slide groove for the mating part to be inserted, the docking part is disposed on the holder body, the docking part includes a slide block and a locking assembly on the slide block, the slide block is slidably connected to the slide groove, and the locking assembly selectively locks the slide block in the slide groove or unlocks the slide block.

13. The car cup mount holder as claimed in claim 12, wherein the locking assembly includes a mounting member, a locking member and an unlocking member, a bottom of the slide block has a mounting groove extending upward, the mounting member is mounted in the mounting groove, the mounting member has a mounting cavity therein, the locking member is slidably disposed in the mounting cavity to slide upward and downward, the slide groove is formed with an engaging groove for engagement of the locking member, a first elastic member is provided between a bottom of the locking member and the mounting member, the unlocking member is slidably disposed in the mounting cavity to slide forward and backward and abuts against the locking member, a second elastic member is provided between one side of the unlocking member and the mounting member, an elastic force of the second elastic member drives the unlocking member to press downward against the locking member, the locking assembly has a locked state and an unlocked state, in the locked state, the unlocking member drives the locking member to overcome the elastic force of the first elastic member and engage in the engaging groove, in the unlocked state, the unlocking member is driven to overcome the elastic force of the second elastic member, causing the locking member to disengage from the engaging groove under the elastic force of the first elastic member.

14. The car cup mount holder as claimed in claim 13, wherein the locking assembly further includes a button, one end of the button, facing away from the unlocking member, protrudes beyond the slide block, another end of the button, facing the unlocking member, has a notch, the unlocking member has a protruding head that mates with the notch, and the button abuts against the unlocking member through engagement of the protruding head and the notch.

15. The car cup mount holder as claimed in claim 13, wherein the unlocking member has a guide slot, the mounting member has a guide block protruding towards the guide slot, the unlocking member is slidably disposed in the mounting cavity to slide forward and backward through engagement of the guide block and the guide slot, and an anti-disengagement member is provided on the guide block for preventing the unlocking member from disengaging from the guide block.

16. The car cup mount holder as claimed in claim 12, wherein a top of the connecting portion extends away from the accommodating room to form a support platform, the slide groove is disposed on a top of the support platform, and the opening faces the accommodating room.

17. The car cup mount holder as claimed in claim 16, wherein two sides of the support platform are connected to tops of the second curved portions via second reinforcing portions.

18. The car cup mount holder as claimed in claim 16, wherein a reinforcing rib is connected between an underside of the support platform and the connecting portion.

19. The car cup mount holder as claimed in claim 11, wherein a first anti-slip pad is provided on one side of the flexible engaging arms, facing away from the accommodating room, for enhancing friction between the flexible engaging arms and the wall of the car cup mount.

20. The car cup mount holder as claimed in claim 11, wherein the body portion has a first reinforcing portion in the form of a rib extending downward on an inner side or an outer side of the accommodating room, and two sides of the first reinforcing portion are connected to the respective flexible engaging arms through first curved portions.
